(19) United States
(12) Patent Application Publication
(10) Pub. No.: US 2016/0062612 A1
(43) Pub. Date: Mar. 3, 2016

(54) Information Access Technique

(71) Applicant: EXEYES Technologies Pvt., Ltd., Ludhiana (IN)

(72) Inventors: Bunny Chum, Ludhiana (IN); Neeti Bansal, Ludhiana (IN)

(21) Appl. No.: 14/839,686

(22) Filed: Aug. 28, 2015

(30) Foreign Application Priority Data
Aug. 29, 2014 (IN) 2472/DEL/2014

(51) Int. Cl. G06F 3/0484; G06F 3/0488; G06Q 30/02; G06F 3/0482

(52) U.S. Cl. CPC G06F 3/04842; G06F 3/0482; G06F 3/0488; G06F 3/04847; G06Q 30/0257

(57) ABSTRACT

The present invention discloses a method for interactively providing information about a product service to a user when the user engages with a special image using an electronic device.

### CROSS-REFERENCE TO RELATED APPLICATION

This application is taking the priority from an Indian Provisional Application No. 2472/DEL/2014 filed on Aug. 29, 2014, which is herein incorporated by reference.

### FIELD OF THE INVENTION

The present invention pertains in general to matrix codes and in particular to a method for generating the matrix code and a method for accessing information by engaging an electronic device with the matrix code.

### BACKGROUND OF THE INVENTION

For advertising a product or service, it is well known to print and display the information about the product or service on various locations which are most frequently visited by the targeted users of the information. But the space availability and query solving has always been a tough regard in such kind of marketing as these methods of advertising are least interactive and therefore the queries of the users remain unanswered most of the time as limited information about the product/service can be displayed in such advertisements.

Some advertisers also print/display URLs of the web-pages containing the information about the product/service with the advertisement. However, few care about typing the whole URLs into their browsers and searching for the information.

Further, accessing the information using two-dimensional (2D) matrix code with embedded information, such as URLs, contact information, e-mail addresses, etc. is also well known in the art, Advertisement using the two-dimensional (2D) matrix codes is gaining a lot of attention as they are easily accessible using readers such as smart-phones, or other similar camera equipped electronic devices. Existing two-dimensional (2D) matrix code scanning techniques mostly rely on the assumption that the information embedded inside the two-dimensional (2D) matrix code will result in the best user experience and hence these techniques redirect the user to the target embedded content without taking any parameter into the consideration and therefore the user experience mostly remains unsatisfactory. in an example, scanning a website URI, of a restaurant embedded inside a two-dimensional (2D) matrix code with an electronic device may redirect a user directly to the target website of the restaurant but this website may not be designed to adapt according to the electronic device of the user and hence it may result in a bad user experience.

Hence, it is apparent that a need exists for a technique that decimates the above mentioned problems to provide a best user experience and also provides maximum ease of access to the information about the advertised product/service. Further, an improved method is also required for generating transparent matrix codes.

The applicant has devised, tested and embodied the present invention to overcome the shortcomings of the state of the art and to obtain these and other purposes and advantages.

### SUMMARY OF THE INVENTION

It is an object of the present invention to provide a system and method for accessing information by engaging an electronic device with a matrix code which results in a best user experience and provides maximum ease of access to the information about the advertised product/service.

It is another object of the present invention to automatically determine at least one of a type of an electronic device and an operating system running on the electronic device upon receiving a request from an electronic device to access the information stored on the server, wherein the request is triggered by scanning a matrix code using the electronic device.

It is yet another object of the present invention to select and display a visual interface from a plurality of visual interfaces wherein the visual interface is selected on the basis of at least one of a determined type of electronic device and an operating system running on the electronic device.

It is yet another object of the present invention to display a first visual interface on a first type of electronic device and a second visual interface on a second type of electronic device, wherein the first electronic devices and second electronic device are running on different operating systems.

It is yet another object of the present invention to provide a method where scanning of a same matrix code by different electronic devices presents different visual interfaces depending on the type of the electronic device used for scanning the matrix code.

To attain the above object, in a first aspect of the present invention, there is provided a computing device which determines at least one of a type of electronic device or an operating system running on the electronic device; wherein the electronic device is used for scanning a matrix code. Preferably, the computing device is a service provider's server; however the same process can be implemented on such as, but not limited to, a local server, an online server, a web based server by doing the required modifications in these servers. The computing device comprises at least one processor and a memory A computer program product is stored in the memory of the computing device which is executed by the processor to detect the operating system running on the electronic device. The computing device is further configured to display an interface containing several user selectable options on the electronic device. The interface is displayed on the basis of the determined operating system of the electronic device. The computing device is further configured to provide information on the basis of an option selected by the user.

It is yet another object of the present invention to provide a method and a system for generating transparent matrix code.

To attain the above object, in a second aspect of the present invention, there is provided a computing device which embeds a frame containing a matrix code on a user selected image. The computing device is further configured to modify at least one characteristic of the matrix code on the basis of user inputs, wherein the characteristics of matrix code are such as, but not limited to, transparency level, position of the matrix code on the background image, size of the matrix code, color of the modules/eves, shape of the modules/eyes, etc. According to the preferred embodiment of the present invention, the computing device is an online server/a web based server, however it should be noted that the same process can be implemented with the help of other electronic devices such as but not limited to, a local server, a smart-phone, a laptop, desktop PC, etc. executing a computer program product wherein the computer program product is designed to implement the same process. The computer program product can be such as, but not limited to, a mobile app, computer implemented software, desktop widget, browser based software, other known similar applications, and combination thereof.

The above and other objects, features, and advantages of the present invention will become more apparent from the following detailed description taken in conjunction with the accompanying with drawings.

### BRIEF DESCRIPTION OF THE DRAWINGS

FIG. 1 illustrates an exemplary architecture of a system to implement the method of the present invention.

FIG. 2 illustrates an exemplary workflow for implementing the first aspect of the present invention.

FIGS. 3-11 illustrate some exemplary interfaces during an implementation of the method disclosed in the present invention.

FIG. 12 illustrates an exemplary workflow for implementing the second aspect of the present invention.

FIG. 13A-13D illustrates various transparent matrix codes generated according to second aspect of the present invention.

### DETAILED DESCRIPTION OF THE PREFERRED EMBODIMENT

In the detailed description section, details about various embodiments of the present invention are set forth in order to provide a thorough understanding of the present invention. The details and examples listed herein are used just to provide a better understanding of the embodiments of the present invention and should not be considered as limiting the scope of the invention. In view of the foregoing, it is intended that all the modifications and variations all within the scope of the following embodiments and their equivalents.

The terms “service provider server”, “computing device”, “local server”, “provider”, “server”, and the plural forms of these terms are used interchangeably throughout herein to refer an entity which provide the matrix code related services as mentioned herein.

The terms “electronic device”, “smart-phone”, “user device”, and the plural forms of these terms are used interchangeably throughout herein to refer to a device which is used by the a user to access the services as disclosed in the present invention.

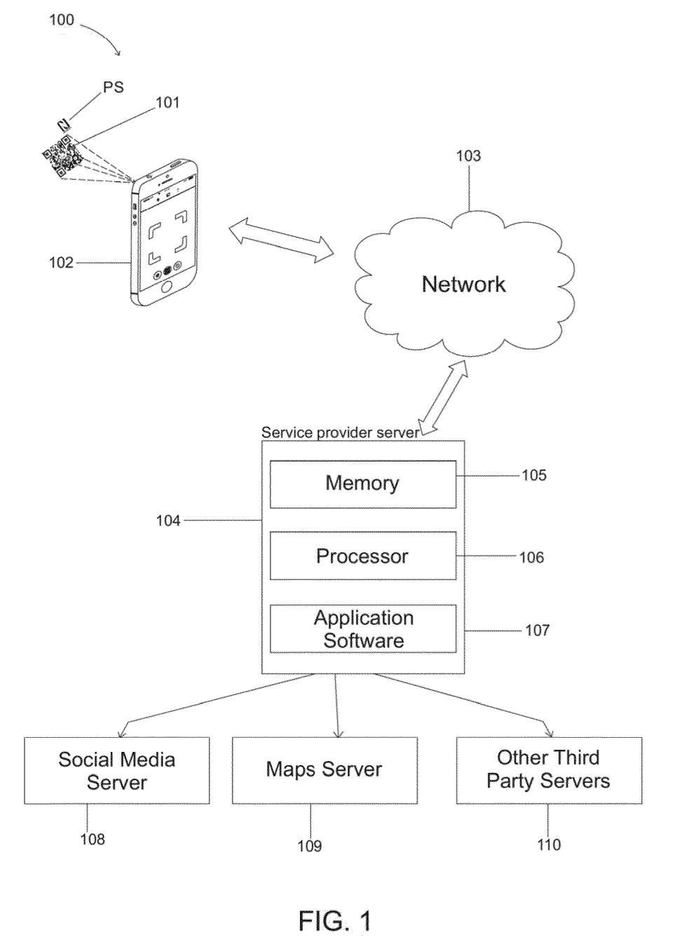

FIG. 1 illustrates an exemplary architecture of a system to implement the method of the present invention. FIG. 1 shows a special image 101. The special image 101 is used to access information about a product or service which is being advertised using the special image 101. The special image 101 contains an access link to the information about the advertised product/service. The access link can be direct URL, an indirect URL, hyperlink, or a combination thereof.

The access link to the information about the product/service to be advertised is embedded in an electronically identifiable image. The electronically identifiable image can be a barcode, quick response (QR) code, a matrix code, transparent matrix, code or any other data containing code known to an ordinary skilled in the art. In an exemplary embodiment, the electronically identifiable: imago can be fused with an ordinary image to generate the special image 101. The ordinary image Can be any image such as a logo of a company, picture of a product to be advertised, trademark, signature, or any other similar image.

As shown in FIG. 1, the special image 101 may also have a proximity sensor PS associated with the special image 101, The proximity sensor PS can be an NFC chip. RFID tag, a touch sensor, audio sensor, IR sensor, Bluetooth or any other type of sensor that can be incorporated for similar purposes as described herein as understood by any ordinary skilled in the art.

An electronic device 102 is used by a user to engage with the special image 101 and proximity sensor (PS). The electronic device can be a mobile phone, a smart phone, a tablet, laptop, PC equipped with a scanner, camera equipped device or any other electronic, device equipped with a code scanner or a proximity sensor. The electronic device 102 can engage with the special image 101 by scanning the electronically identifiable image contained inside the special image 101 using a code scanning application installed in the electronic device 102.

In addition to scanning the electronically identifiable image contained in the special image 101, the electronic device 102 can also engage with the special image 101 by triggering the proximity sensor PS associated with the special image 101.

When the user engages with the special image 101, the access link contained in the special image 101 is activated and a request for the information about the advertised product/service is automatically transmitted to a service provider server 104 via a network 103, The network 103 can be any wired or wireless communication link such as but not limited to PSTN, LAN, WAN, WLAN, wi-fi, wi-max, Bluetooth, ISDN, or combination thereof.

The server 104 is a service provider server which is configured to provide the services related to the electronically identifiable image as disclosed in the present invention.. The service provider server 104 includes a memory 105, a processor 106, and application software 107. The memory 105 is a data storage device and can be any of a volatile or a non volatile memory such as, but not limited to, RAM, ROM, DRAM EROM, EPROM, EEPROM, flash memory, NVRAM, CMOS, or any other memory. The memory 105 stores at least some of the information about the advertised product/service. The information related to the advertised product/service may include a webpage, URL, website, a menu card of a restaurant, reviews about a restaurant, movie details on an advertisement/promotion board, social media page of service/product provider, detailed specifications of a product, feedback form, enquiry form, map navigation, special offers, rating of product/service, reviews about the product/service or any other such information as known to an ordinary skilled in the art.

The processor 106 is responsible for all the processes of the system such as responding to the request from the electronic device 102, providing access to the information stored on the memory 105, etc. The service provider server 104 can also include multiple processors 102 and memories 105.

The application software 107 is a software code which is stored in the service provider server 104. The application software 107 may be stored in the memory 105 or in a separate memory. The method disclosed in the present invention is implemented through the application software 107.

When a request for the information about the advertised product/service is received at the service provider server 104, the processor 106 fetches the suitable instructions from the application software 107 and determines at least one of a type of the electronic device 102, Operating System OS of the device 102, and combination thereof The processor 106 fetches the suitable instructions from the application software 107 to display a visual interface containing several user selectable options on the electronic device 102. The visual interface displayed on the electronic device 102 is adaptable responsive according to at least one of the determined type of electronic device, the operating system running on the electronic device 102, and the combination thereof In other words, the GUI of the application software 107 is displayed on the electronic device 102 on the basis of at least one of the type of electronic device and the operating system running on the electronic device 102. The type of the electronic device can be such as, but not limited, to, device ID, brand name, screen size, display resolution, etc.

The user makes the selections for desired information using a GUI of the electronic device 102. The processor 106 receives the user selections over the network. 103 and based on the received selections, provides the information to the user of the electronic device 102. The information provided to the user is based on the user selections. For example, if the user desires information which is stored on the service provider server 104 such as details about the advertised product/service or feedback form for the product/service, the information is provided directly from the memory 105 of the service provider server 104.

If the user desires information about the product/service stored on any other server, then user of the electronic device 102 is connected with the corresponding server. For example if the user desires to visit a social media page of the advertised product/service, user is connected to the desired social media server 108. If the user desires to view a location map of the advertised product/service, then the user is connected to a map server 109. If the user desires information that is provided by any other third party linked to the product/service provider, the service provider server 104 connects the user to the other third party servers 110. The other third party servers can be financial institution servers providing payment options, ecommerce websites, etc.

According to another exemplary embodiment of the present invention, the special image 101 and the associated proximity sensor can be embedded within a physical module. The physical module can be a hanging module, a table stand, packaging, wall mountable, advertisement board. flex, a sheet of paper, glass pane, metal sheet, visiting card, or any other such modules as known to an ordinary skilled in the art.

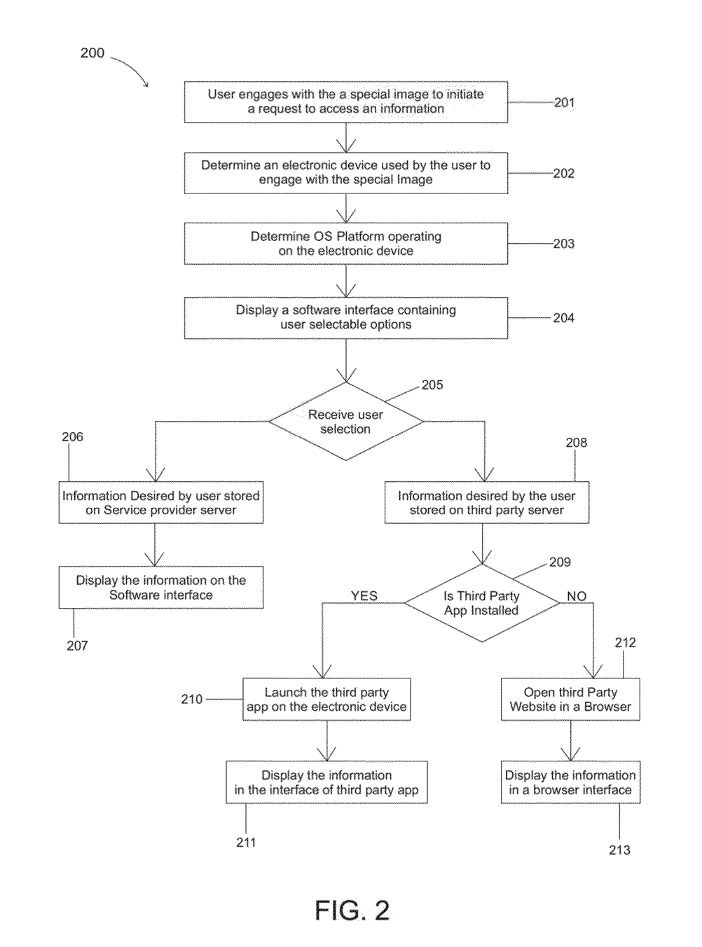

FIG. 2 is a flow chart 200 of a method to advertise a product or service according to an exemplary embodiment of the present invention. Although the process 200 is described in context of advertised products/services, it should be noted that the same process can also be implemented to provide other services like “display nearest location, “add to calendar”, “add to contacts”, “promotions” “social media pages”, etc. The process starts at 201 when a user interested in an advertised product/service engages with a special image using an electronic device. The special image is used to provide information of a product/service. The special image contains an access link to the information about the advertised product/service. The user can engage with the special image either by scanning an electronically identifiable image, contained inside the special image, using scanner app installed in a mobile phone or by triggering the proximity sensor associated with the special image using a functionality of the mobile phone. The functionality for triggering the proximity sensor can be a combination of hardware and software components. When the user uses the electronic device to engage with the special image, an access link to information about the advertised product/service contained in the special image is identified and the electronic device generates a request to access the information about the product/service and transmits the request to a service provider server.

Once the request is received by the service provider server, at step 202 the application software automatically determines whether the electronic device used to engage with the special image is a mobile phone, tablet, laptop, or any other electronic device. At step 203, the application software automatically determines the operating platform executing on the electronic device. The operating platform of the electronic device is determined so as to provide the information about the advertised product/service in accordance with its compatibility with the operating system of the electronic device.

At step 204, the service provider server provides a visual interface containing several user selectable options to the electronic, device wherein the visual interface is displayed on the electronic device. The visual interface is displayed on the basis of at least one of the type of the electronic device and the determined operating system of the electronic device. The user selectable options correspond to specific information about the advertised product or service. The user selects an option according, to information about the product/service desired by the user.

At step 205, the user selection is received by the service provider server and it is automatically determined whether the information desired by the user is stored on the service provider server itself or on a third party server. The third party server can be a social media server, location nap server, financial institution server, ecommerce server, or any other such server known. to an ordinary skilled in the art.

If it is determined that the information desired by the user is stored on the service provider server, the process moves to step 207 via step 206. At step 207, the desired information is displayed in the visual interface on the display screen of the electronic device.

If it is determined that that the information desired by the user is stored on a third party server, the process moves to step 209 via step 208. At step 209, it is determined whether a third party application is installed on the electronic device is not. This determination can be made either automatically or manually by asking the user via a pop up box. The third party application may be a social media application, financial institution application, a route map navigation application, or any other third party application.

If the third party application is installed on the electronic device, then at step 210, the third party application is launched on the electronic device and at step 211, the desired information is displayed in the interface of the third party application. Also, if the application is already installed on the user device, user may be already logged in to the third party application. So, the desired information can be quickly displayed in the interface of the third party application.

If the third party application is not installed on the electronic device, then at step 212, a web browser is launched on the electronic device and a third party website is opened in the browser window and at step 213, the desired information is displayed in the browser information as a webpage.

Various modifications can be made to the process described above. One non limiting modification can be that upon determining that the third party application is not installed on the electronic device, the user can be prompted to install the third party application by automatically launching the app store according, to the operating system of the electronic device. All other Modifications which will be obvious to an ordinary skilled in the an should be considered within the scope of the preset invention.

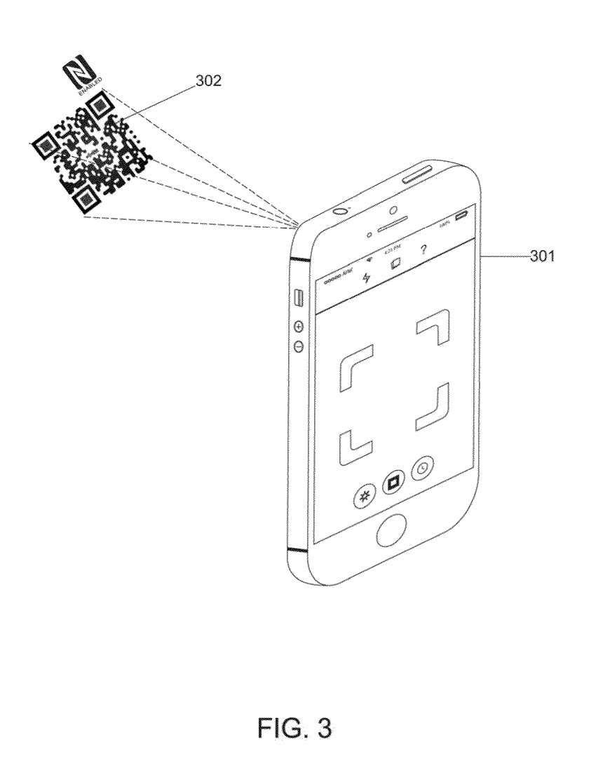

FIGS. 3-11 illustrate some exemplary interfaces of the electronic device during an implementation of the method disclosed in the present invention according to an exemplary embodiment.

FIG. 3 shows an electronic device 301 and a special image 302. The electronic device 301 scans an electronically identifiable image contained in the special image 302 using a scanner application installed in the electronic device 301. it is just an exemplary way of engaging with the special image 302 and should not be considered as limiting the scope of the invention. Another way to engage with the special image 302 is by triggering a proximity sensor associated with the special image 302 using the electronic device 301.

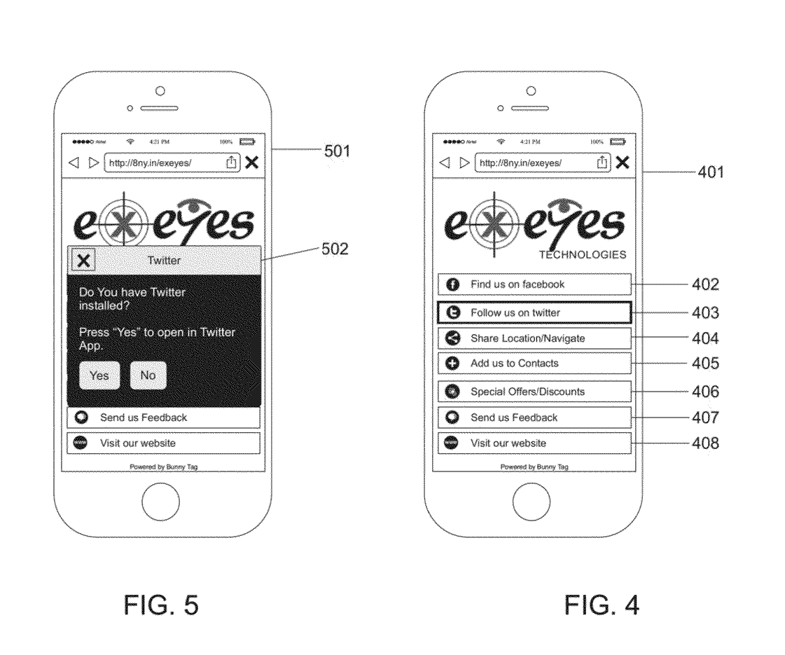

FIG. 4 depicts an exemplary interface of an electronic device 401 with several options 402-408 displayed on the electronic device 401. The options include options to visit a social media page of the advertised product/service ex-eyes technologies in this example), options for location navigation of a concerned individual/company providing the advertised product/service, options to view special offers for the advertised product/service, feedback form, etc. A. user of the electronic device selects an option according to the information he wants to view and the corresponding information is provided to the user as shown in FIG. 5. According to an exemplary embodiment of the present invention, the user selects the option 403 i.e. “Follow us on twitter”, wherein twitter is a registered trademark of Twitter Inc. However it should not be considered as limiting the scope of the present invention to option 403 only any option can be selected by the user.

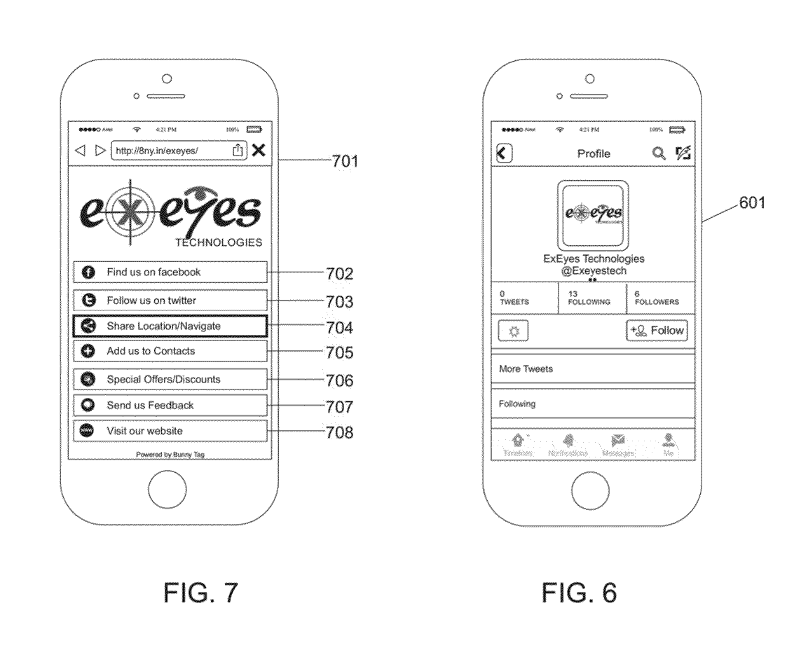

FIG. 5 shows an exemplary visual interface according to a selection made by the user. FIG. 5 shows an electronic device 501 showing a pop-up box 502 asking the user whether the twitter® application is installed in the electronic device 501. According to an exemplary embodiment of the present invention, the user selects option “Yes” and the corresponding information is displayed to user as shown in FIG. 6.

As clear from the FIG. 6, upon determining that the twitter® application is installed on the electronic device, launching the twitter® application on the electronic device 601 and displaying the twitter® page of the service provider/third party in the interface of the launched application.

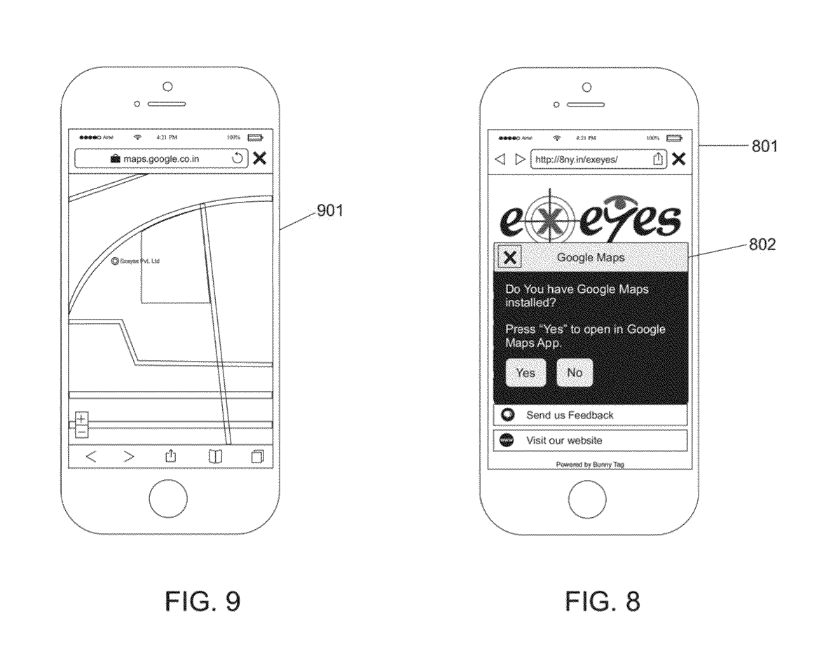

FIG. 7 depicts another exemplary interface of an electronic device 701 with several options 702-708 displayed on the electronic device 701 and the user of the electronic device selects the option 704 i.e. “Share location/Navigate”. The selection will take the user to an interface as shown in FIG. 8.

FIG. 8 shows an interface of an electronic device 801 according to a. user selection made by the user as explained with reference to FIG. 7. As shown in FIG. 8, the electronic, device 801 displays a pop-up box 802 asking the user whether the google maps® application is installed in the electronic device 801. According to an exemplary embodiment of the present invention, the user selects option “No” and the user is connected to the server of google maps® and a corresponding website is opened in a browser of the electronic device as shown in FIG. 9

FIG. 9 shows an interface of an electronic device 901 displaying the location of the concerned individual/company in a website opened in a browser installed in the electronic device 901.

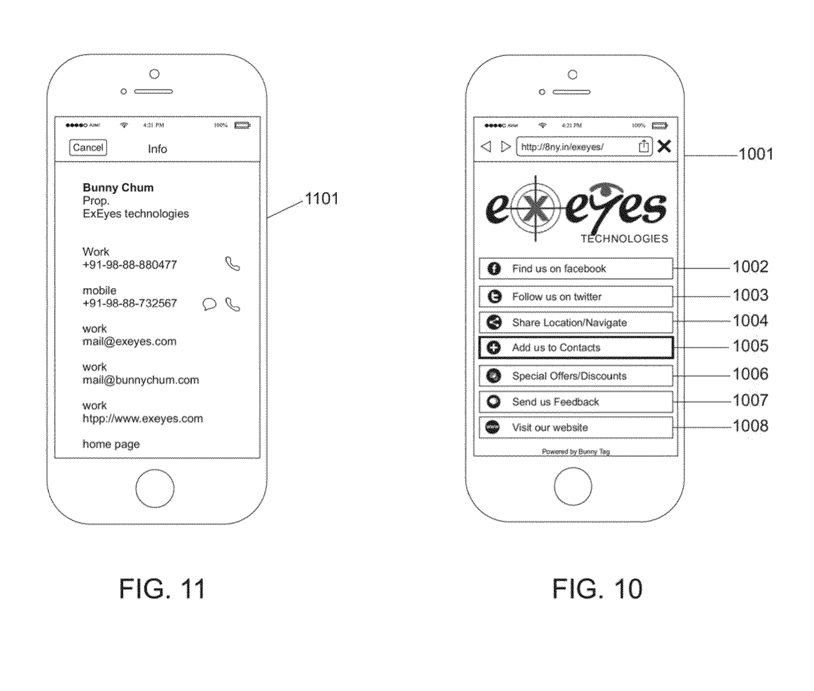

FIG. 10 depicts another exemplary interface of an electronic device 1001 with several options 1002-1008 displayed on the electronic device 1001 and the user of the electronic device selects the option 1005 i.e. “Add us to contacts”. The selection will take the user to an interface as shown in FIG. 11.

FIG. 11 shows an interface of an electronic device 1101 according to a user selection made by the user as explained with reference to FIG. 10. When the user selects the option “Add us to contacts”, corresponding information is fetched from a server of the provider (i.e. ex-eyes technologies in this example) and the contact information is added to the director of the electronic device 1101. In another embodiment of the present invention, other similar options such as “add to calendar”, “display nearest location”, etc. can also be provided to the user. In an exemplary scenario, an electronically identifiable image contained in the special image may be designed to provide information about events such as meeting, wedding, social gathering, party, etc. When the user scans the electronically identifiable image by using the electronic device, a visual interface is provided, by the service provider server, which is displayed on the electronic, device. The visual interface is provided by the service provider server depending upon either a type of the electronic device. OS running on the electronic device, or both. The visual interface is designed to adapt according to the electronic device so that it results in the best user experience. The visual interface include options such as, but not limited to. “add to calendar” by selection of which the associated event information is added in the calendar of the electronic device.

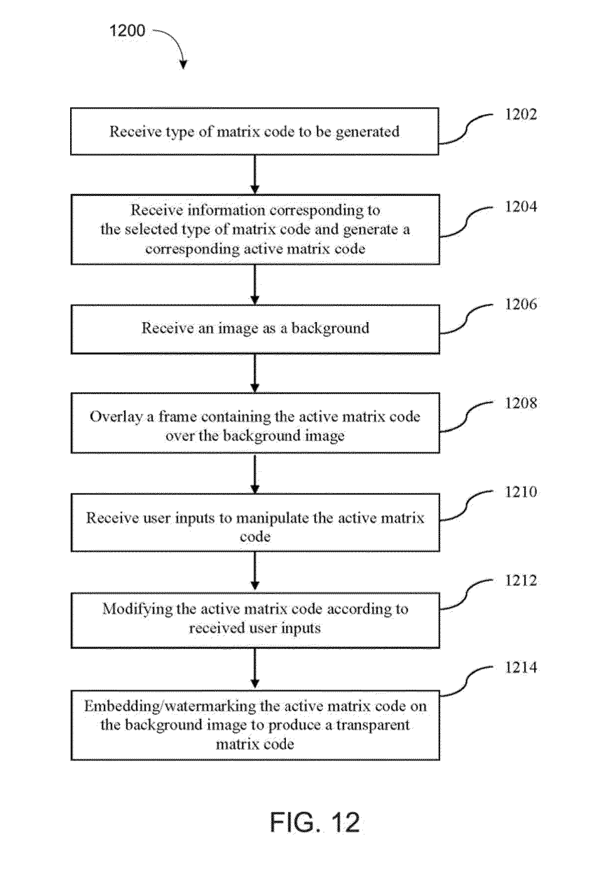

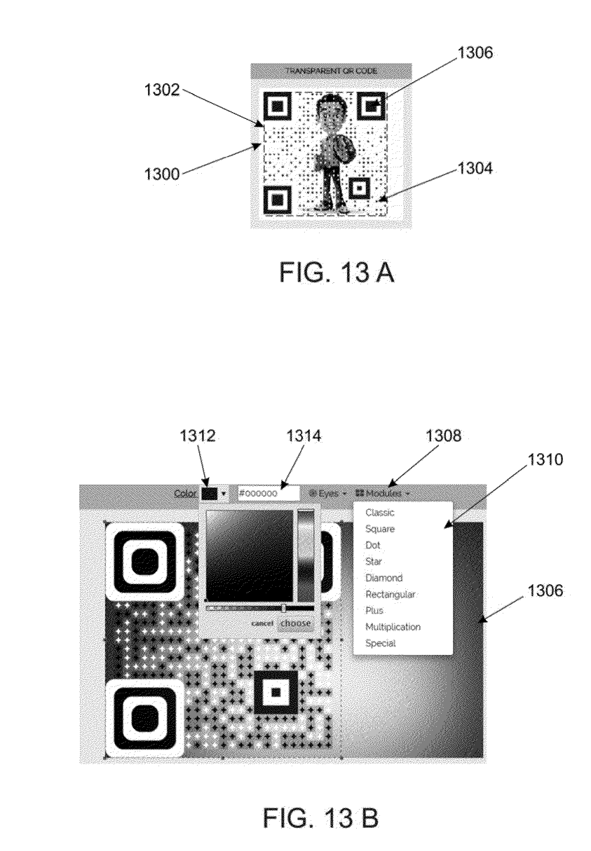

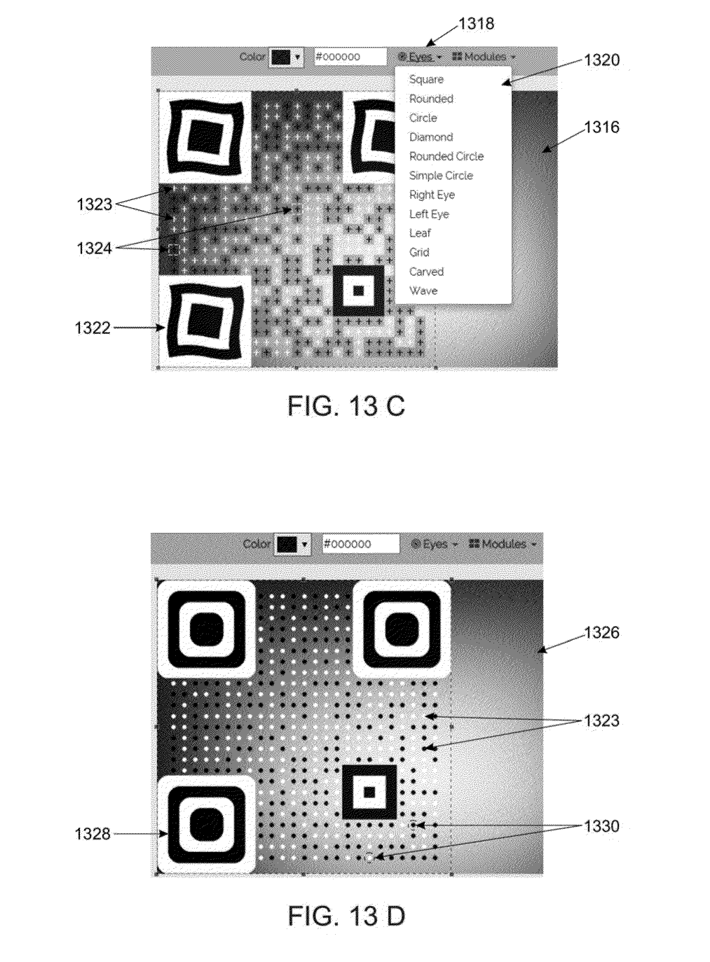

FIG. 12 illustrates an exemplary flow diagram for generating the transparent special images according to another aspect of the present invention. It should be noted that the various steps of the flow diagram has been simplified for better exemplification and these steps are explained in greater details with reference to the following description. The flowchart 1200 of FIG. 12 will be better understood with reference to various types of transparent special images as depicted in FIG. 13. The transparent special image as shown in FIG. 13A comprises a background image 1300 and a frame 1302 containing an electronically identifiable image. FIG. 13 is just for illustrative purpose and various modifications in the same can be understood by an ordinary skilled in the art. The electronically identifiable image can be such as, but limited to a, barcode, QR code, matrix code, 2D responsive codes or any other data containing code known to an ordinary skilled in the art. The electronically identifiable image is herein after referred as matrix code for simplicity. The matrix code (i.e. electronically identifiable image) comprises black dots 1304 arranged in a grid form (referred as “modules”) on the background image 1300 and four “eyes” 1306 arranged at four corners of the frame.

In preferred embodiment, the process as described in flow diagram 1200 can be implemented on a website hosted by an online server which comprises at least a memory and a processor. It should be noted that the below laid out description is an exemplary scenario and shall not be understood as a limitation thereof. In another embodiment, the process 1200 can be also be implemented, without the webpage hosted on the online server, by using a computer implemented program product such as, but not limited to, a mobile app, computer implemented software, desktop widget, browser based software, other known similar applications, and combination thereof.

The process begins with step 1202 in which a user accesses a webpage, by using an electronic device, for creating a transparent matrix code wherein the webpage is being hosted on the online server. The electronic device can be any computerized electronic device for example, and without limitation, a mobile device, a smart-phone, a personal computer, a microcomputer, a work station, a notebook computer, a personal digital assistant (FDA), a hand held personal computer (PC), or other similar computing apparatus. The online server, upon receiving a request from the user for creating the custom matrix code, presents a plurality of options to the user by which the user can specify the type of the matrix code to be generated. The options can be for example, without limitation, an option for creating URL based matrix code, an option for creating social-network matrix code an option for creating coupon matrix code, an option for creating contact-us matrix code, an option for creating promotion matrix code, an option for creating all-in-one matrix code, etc.

Once the user has specified the type of the matrix code to be created, the online server provides a graphical interface for receiving the information that is required to create the selected type of matrix code, in step 1204. The information related to matrix code can be for example, without limitation, URL, of target website (Facebook, twitter, company website, Google+, etc.), contact information, text, company name, e-mail address, residential/company address, coupon details, etc. Processor of the online server uses the information provided by the user at d generates an active matrix code. The generated code is referred as the “active matrix code” because scanning the same by the electronic device provides the information associated with it.

After receiving the information related to the matrix code, the process moves to step 1206 where a graphical user interface (GUI) is presented to the user by which the user selects an image by either uploading an image or choosing an image from a pre-stored library. The image provided by the user is used as the background image 1300.

In step 1208, a frame 1302 containing the active matrix code, generated in step 1204, is overlaid on the background image 1300 to form a composite image 1300 which is presented to the user on the webpage being displayed on the electronic device. Further, a graphical interface is also displayed on the webpage with user selectable options (1312, 1314, 1318 as shown in FIG. 13B) which are used by the user to modify the characteristics of the active matrix code.

In step 1210, the user selects options for modifying the active matrix code (shown in FIG. 13) by using input devices interfaced with the electronic device. The user inputs can be related to such as, but not limited to, re-sizing the frame, floating/moving the frame over the background image, reshaping the matrix code, changing the color of the modules of the matrix codes, changing the shape of the matrix code modules (i.e. dot, square, diamond, plus sign, minus sign, etc. changing the transparency level of the matrix code, etc. The selected module shapes are pre-set to be smaller in size of the actual module's column/box by leaving rest of the column/box/pixel of the module to either semi-transparent (as shown in FIG. 13C) or fully transparent (as shown in FIG. 13D) according to the user's selection. The input devices can be such as, but not limited to, a keypad, a mouse, a touchpad, a touch-screen and combination thereof. The step 1210 can be repeated by the user over and over again to modify the active matrix code according to the requirements. In step 1212, the processor of the online server modifies the active matrix code according to the commands received by the user of the electronic device.

In step 1214, the active matrix code 1302 is embedded over the background image 1300 to form a composite image containing a transparent matrix code. The transparent matrix code generated using the inventive concept of the present invention can be easily accessible by the electronic device and is better styled as compare to the existing techniques.

FIGS. 13B, 13C and 13D illustrate the various aspects of the present invention according to step 1210, 1212 and 1214 of the process 1200. As illustrated in FIG. 13B, a graphical user interface is displayed on the webpage accessed by the user having plurality of options such as 1308, 1312 and 1314. Option 1308 allows a user to modify the shape of the modules 1304 of the matrix code by selecting from a plurality of pre-define shapes of the modules of the matrix code 1302. For example, modules can be changed to different shapes such as dots, diamonds, plus, minus, star, rectangle, square, etc. Option 1312 allows the user to modify the color of the matrix code. Option 1314 allows the user to specify a particular color code which is known to the user.

FIG. 13C illustrates an exemplary graphical user interface comprising a button 1318 using which the user can modify the shapes of the “eyes” 1322 of the matrix code. When a user clicks on button 1318, a drop down menu 1320 is displayed in which different pre-set shapes of the “eyes”1122 can be selected.

The modules of the matrix code (1323, 1329) are designed in such a way that they cover only a part of the actual module's box and the remaining area of the column/box of the actual module can be kept to either semi-transparent or fully transparent depending on the user's selection, explained in detail with reference to FIG. 13C and FIG. 13D.

The processor of the online server is pre-set to convert each module of the active matrix code into user-defined shapes 1323 (i.e. “plus” shape in FIG. 13C). Modified module shapes 1323 are pre-set to be smaller in size of the actual module's column/box 1324 by leaving the surrounding remaining area of the modified module shapes 1323 (area between 1323 and 1324) to semi-transparent as selected by the user. Actual modules are represented by 1324.

FIG. 13D illustrates another embodiment where the shape of the modules is selected to be in the form of “dots” 1329 and the selected shape 1329 (dots) of the modules is set to be smaller in size of the actual modules column/box 1330 by leaving the surrounding area (area between 1329 and 1330) to fully transparent as selected by the user.

Embodiments related to generating a transparent matrix code are explained with the help of an exemplary scenario of the online server and it should not be considered as a limitation thereof. The applicant has devised and tested the same aspect using a computer implemented program product such as, but not limited to, a mobile app, computer implemented software, desktop widget, browser based software, other known similar applications, and combination thereof.

From the foregoing detailed description of certain preferred embodiments, it will be apparent that various modifications, additions and other alternative embodiments are possible without departing, from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention.

What is claimed is:

1. A computer implemented method for providing access to an information, the method comprising:
receiving a request from an electronic device to access the information stored on a server, wherein the request is triggered upon identifying an electronically identifiable image using the electronic device;
determining at least one parameter associated with the electronic device;
providing a visual interface to be displayed on the electronic device on the basis of the at least one determined parameter associated with the electronic device.

2. The computer implemented method of claim 1, wherein the parameter is one or more of a type of the electronic device and an operating system running on the electronic device.

3. The computer implemented method of claim 1, wherein the electronically identifiable image is one or more of a one dimensional code, a two dimensional code, a quick response code and a matrix code.

4. The computer implemented method of claim 1, wherein the request is triggered upon identifying the electronically identifiable image by at least one of the following: scanning the electronically identifiable image and triggering a proximity sensor linked to the electronically identifiable figure.

5. The computer implemented method of claim 4, wherein the proximity sensor linked to the electronically identifiable image is at least one of a touch sensor, NFC chip, audio sensor, RFID tag, IR sensor and Bluetooth.

6. The computer implemented method of claim 1, wherein the information comprises one or more of social media content, feedback form, product details, enquiry form, maps, offers, tokens, advertisement, event information and contact information.

7. The computer implemented method of claim 1, wherein the visual interface adapts according to the electronic, device, and displays a plurality of user selectable options to access the information.

8. The computer implemented method of claim 1 further comprises:
receiving a user selection from a plurality of user selectable options displayed on the visual interface to launch an app on the electronic, device which is required for displaying the information associated with the user selectable option.

9. The computer implemented method of claim 8, wherein the app is a web-browser or a third party app installed on the electronic device.

10. A computer implemented method for generating a transparent matrix code, the method comprising:
receiving a desired information associated with the transparent matrix code;
receiving a background image from a user;
overlaying a frame containing, a matrix code on the background image, wherein the matrix code provides the desired information when triggered by the electronic device;
receiving user input for modifying at least one characteristic of the matrix code;
modifying the matrix code according to the received user inputs to generate the transparent matrix code;
embedding the frame containing the transparent matrix code on the background image.

11. The computer implemented method of claim 10, wherein the matrix code, contained in the frame overlaid on the background image, is active matrix code comprising an access link to the desired information.

12. The computer implemented method of claim 10, wherein the user input comprises at least one of inputs for modifying, shape of modules, inputs for modifying size of matrix code, inputs for modifying position of the matrix code on the background image, inputs for modifying shape of eyes, inputs for modifying transparency level of matrix code, inputs for modifying the color of matrix code, and combination thereof.

13. The computer implemented method of claim 10, wherein the transparent matrix code is generated by modifying modules of the matrix code according to user inputs such that the modified modules are smaller in size as compared to actual module size and remaining surrounding area of the modified modules is set to be either fully transparent or semi-transparent depending, on the user inputs.

14. The computer implemented method of claim 10, wherein the desired information comprises one or more of social media content, feedback form, product details, enquiry form, maps, offers, tokens, advertisement, event information and contact information.

15. A server for providing access to an information, the server comprising:
a processor configured to execute computer program code; and
a data storage device configured to store computer program code that is able to be executed by the processor, the computer program code stored in the data storage device comprising at least:
computer program code for receiving a request from an electronic device to access the information stored on a server, wherein the request is triggered upon recognizing an electronically identifiable image using the electronic device;
computer program code for determining at least one parameter associated with the electronic device;
computer program code for providing a visual interface to be displayed on the electronic device on the basis of the at least one determined parameter associated with the electronic device.

16. The server of claim 15, wherein the parameter is one or more of a type of the electronic device and an operating system running on the electronic device.

17. The server of claim 15, wherein the electronically identifiable image is one or more of a one dimensional code, a two dimensional code, a quick response code and a matrix code.

18. The server of claim 15 further comprises computer program code for displaying a first visual interface for a first electronic device and a second visual interface for a second electronic device.

19. The server of claim 15 further comprises computer program code for receiving a user selection from a plurality of user selectable options displayed on the visual interface to launch an app on the electronic device which is required for displaying the information associated with the user selectable option.

20. The server of claim 19, wherein the app is a web-browser or a third party app installed on the electronic device.
